(19) United States
(12) Patent Application Publication
(10) Pub. No.: US 2012/0150990 A1
(43) Pub. Date: Jun. 14, 2012

(54) SYSTEM AND METHOD FOR SYNCHRONIZING WITH MULTIMEDIA BROADCAST PROGRAM AND COMPUTER PROGRAM PRODUCT THEREOF

(75) Inventor: Wen-Shan LIOU, Taipei County (TW)

(73) Assignee: INSTITUTE FOR INFORMATION INDUSTRY, TAIPEI (TW)

(21) Appl. No.: 12/978,422

(22) Filed: Dec. 24, 2010

(30) Foreign Application Priority Data
Dec. 9, 2010 (TW) 099143029

(51) Int. Cl. G06F 15/16

(52) U.S. Cl. 709/217

(57) ABSTRACT

A system and a method are provided for synchronizing with at least one multimedia program that is being broadcasted. The system includes a context server and a client-side device. The context server is configured to provide at least one context event of each multimedia program, wherein the context event is generated in accordance with occurrence of at least one predetermined context item in context contents of each multimedia program. The client-side device is used for receiving and parsing the context event, thereby obtaining at least one set of context event data of each multimedia program. The client-side device also includes at least one application means for performing at least one action based on the set of context event data.

### RELATED APPLICATIONS

This application claims priority to Taiwan Application Ser. No. 099143029, filed Dec. 9, 2010, which is herein incorporated by reference.

### BACKGROUND

1. Field of Invention

The present invention relates to a system and method for synchronizing with a multimedia program, and more particularly, related to the context-based system and method for synchronizing with a multimedia program

2. Description of Related Art

With the advance of information technologies, interactive services via Internet have gradually become popular with viewers. An interactive service allows a client side to perform certain actions along with the broadcast of a program when the program is being broadcasted, thereby responding to the program contents. A conventional skill is based on, for example, a network time protocol (NTP) or a universal time of a global positioning system (GPS) to synchronize the time at a client-side device with the broadcast time of a TV program. In the conventional skill, the client-side device has to set up a time-action table in advance, and check time and synchronize with a TV station, wherein actions sequentially arranged in accordance with broadcasting time points of a TV program are set up in the time-action table. Then, when the broadcast of TV program reaches a certain broadcasting time point, the client-side device may perform the action designated at this broadcasting time point in the time-action table, for example, displaying the question being asked by the host; displaying the introduction of a main character which is acting, etc., thereby enhancing TV viewing experience.

However, the fabrication of the conventional time-action table requires the respective broadcasting time points of the TV program accurately, and broadcasting time points cannot be obtained until the production of TV program is completed, and thus the conventional skill is not suitable for use in a live program. The conventional action-time table has to be made specifically for each TV program, and thus one action-time table is applicable to only one TV program in a one-to-one manner and cannot be repetitively used in other TV programs.

### SUMMARY

An object of the present invention is to provide a system and a method for synchronizing with a multimedia program (such as TV, radio or any other media program) by using context events occurring in the multimedia program, thereby overcoming the aforementioned disadvantages of the conventional skill.

Hence, an aspect of the present invention is to provide a system for synchronizing with at least one multimedia program which is being broadcasted. The system includes a context server and a client-side device. The context server is configured to provide at least one context event for each multimedia program, wherein the context event is generated in accordance with occurrence of at least one predetermined context item in context contents of each multimedia program. The client-side device is used for receiving and parsing the context event of each multimedia program, thereby obtaining at least one set of context event data of each multimedia program. The client-side device includes at least one application means for performing at least one action based on the set of context event data.

Another aspect of the present invention is to provide a method for synchronizing with at least one multimedia program that is being broadcasted. In this method, the multimedia program that is being broadcasted is first obtained. Then, at least one context event for each multimedia program is generated in accordance with occurrence of at least one predetermined context item in context contents of each multimedia program. Thereafter, the context event of each multimedia program is received and parsed so as to obtain at least one set of context event data of each multimedia program. Then, at least one action based on the set of context event data is performed.

According to an embodiment, the aforementioned method for synchronizing with the multimedia program further includes setting up a context-action table and performing the action by comparing the set of context event data of each multimedia program to the context-action table. In the context-action table, the predetermined context item and the action corresponding thereto are set up.

According to another embodiment, the aforementioned method for synchronizing with the multimedia program further includes selecting at least one filtering conditions for filtering out the context event of each multimedia program.

It can be known from the aforementioned embodiments that the application of the present invention has the following advantages. The client-side device merely needs to designate in advance the event items (predetermined context items) which likely occur in multimedia programs, and actions desired to be performed, i.e. the context-action table. Thus, the present invention does not need to check time with the TV or radio station and collaborate with the fabrication progress of the multimedia programs, and also is not affected by the changes of program contents. The present invention is applicable to live or real-time programs; can be repetitively used in multimedia programs with similar contexts (such as soap operas); can filter out context events conditionally for providing personal services; and can receive the context events from several programs at the same time. Further, the application means of the present invention can be linked to the multimedia programs more flexibly than the conventional “synchronization with time” does, and thereby the application programs interactive with the multimedia programs can be fabricated separately or developed by independent third parties and still maintaining linkage operations between the client-side device and the multimedia programs.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a functional block diagram showing a system for synchronizing with a multimedia program according to an embodiment of the present invention;

FIG. 1B is an exemplary schematic diagram showing the context event data shown in FIG. 1A; and

FIG. 2 is a flow chart showing a method for synchronizing with a multimedia program according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention mainly rely on the context events occurring in a broadcasting TV or radio program to synchronize a client-side device with the TV or radio program. By using the context events associated with the contents of the program to perform synchronization, the client-side device does not need to check time with a TV or radio station, and thus avoids the shortcomings of the conventional “synchronization with time”. For example, embodiments of the present invention are applicable to life programs.

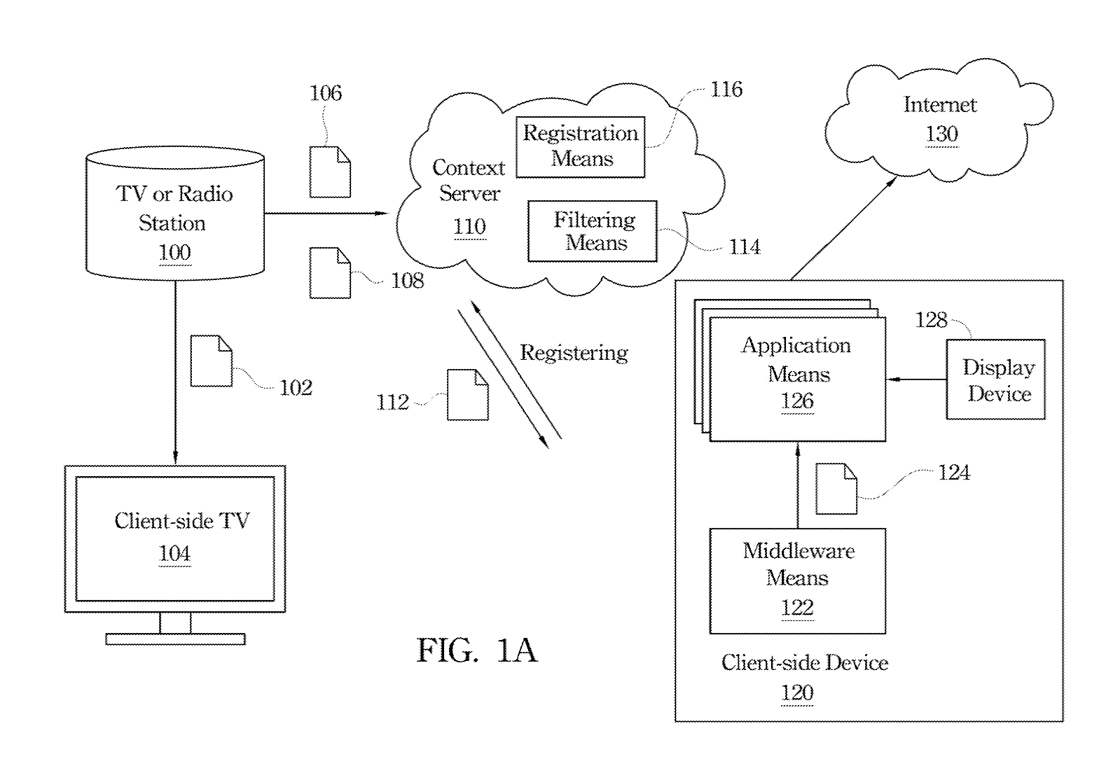

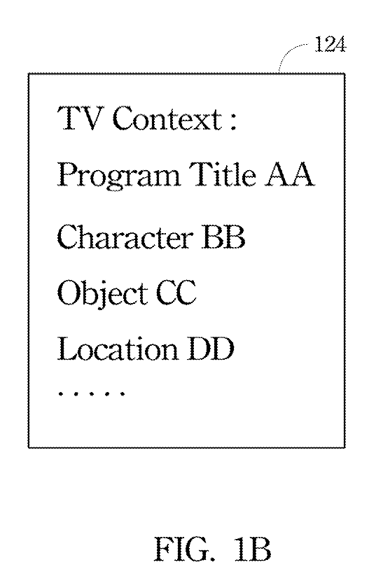

Referring to FIG. 1A, FIG. 1A is a functional block diagram showing a system for synchronizing with a multimedia program according to an embodiment of the present invention. The system includes a context server 110 and a client-side device 120. The context server 110 may be, for example, a cloud server which communicates with the client-side device 120 via Internet 130. The client-side device 120 may be, for example, a cell phone, a personal digital assistant (PDA) or a remote control, etc. The client-side device 120 also may be integrated into a client-side TV 104. The client-side device 120 may allow a user to interact with and respond to at least one multimedia program 102 at the same time when viewing the multimedia program 102, thereby achieving the effects of Internet TV or interactive TV, for example.

In this embodiment, the at least one multimedia program 102 may be at least one TV or radio program which is being broadcasted by at least one TV or radio station 100. However, the multimedia program 102 also can be the program which is being broadcasted by any media, such as a streaming program broadcasted at a website. Therefore, embodiments of the present invention are not limited thereto.

The context server 110 may obtain context contents 106 of the multimedia program 102 and an electronic program guide (EPG) 108 from the TV or radio station 100. The EPG 108 is provided to help the context server 110 to schedule the generation of the context event 112. The context server 110 is configured to provide at least one context event 112 of the multimedia program 102 to the client-side device 120, thereby synchronizing the client-side device 120 with the multimedia program 102 via the context event 112. The context event 112 is generated in accordance with occurrence of at least one predetermined context item in the context contents 106 of the multimedia program 102, wherein the predetermined context items are the samples of critical words, voice and images representing the context contents 106, i.e. the context contents worthy to be noted by viewers in the multimedia program 102, such as a major character showing up, an event occurrence (such as raising a question), a scene switch, a critical voice appearing or their combinations. The predetermined context items can be repetitively used in the TV or radio programs with similar contexts (such as soap operas, sports programs, etc.), and the context event 112 can be shown in a structured language format, such as a XML (eXtensible Markup Language) format.

The context contents 106 can be the multimedia program 102 itself or a script of the multimedia program 102. If the context contents 106 is the script of the multimedia program 102, the context event 112 can be recognized directly from the script of the multimedia program 102, since all the details regarding the events and characters of the multimedia program 102 can be known prior to the broadcast of the multimedia program 102. Hereinafter, the case that the context contents 106 is the multimedia program 102 itself is used as an example for explaining the generation of the context event 112. Certainly, when the multimedia program 102 is a radio program, the related context event 112 can be generated in accordance with the following description regarding voice recognition.

When receiving the context contents 106 of the multimedia program 102 which is being broadcasted, the context server 110 detects whether the predetermined context item has appeared in the context contents 106 by using audio/video recognition software or an artificial recognition method, and then a string message representing the predetermined context item appearing in the context contents 106 is processed as a context event 112. Before processing the context contents 106, the samples (predetermined context items) of critical words, voice and images representing the context contents have to be prepared in advance for comparison. Hereinafter, an example is used for explaining the steps of generating the context event 112, but embodiments of the present invention are not limited thereto. At first, a step is performed for detecting a scene appearing in a TV program. Since a TV program is composed of a plurality of scenes, a shot change detection algorithm can be used to detect a new scene appearing. Then, by comparing the samples (predetermined context items) with the data of images, voice and captions shown in each scene, a sample comparison method is applied to search for the context items appearing in the current scene. With respect to the image portion, one or more images are first retrieved from critical frames of each scene, and then algorithms of object recognition and face recognition are applied to detect the objects or characters matching with the predetermined context items appearing in the respective critical frames. With respect to the voice portion, a frequency band filtering method is applied to separate speech from voice in each scene, and then speech-to-text software is used to generate dialogue or narration text strings. If the TV program has already had closed captions, the voice recognition may be omitted and the data of closed captions are directly used for detecting whether the critical words representing the predetermined context items have appeared. Thereafter, text strings are used to represent all of the context items detected in the current scene, and are written in a structured language format, thereby obtaining the context event 112.

It is worthy to be noted that additional recognition methods can be applied to various types of TV programs to enhance the recognition rate. For example, with respect to TV sports programs, the changes of narrator's voice in volume, tune and speed can be compared to detect a special event occurrence (such as a home run). With respect to TV game shows, a close-up image of question text with accompanying speech reading out the question can be distinguished for more accurately detecting the question-raising event.

The context server 110 includes a registration means 116 and a filtering means 114. When desiring to request a service from the context server 110, the user first has to register with the context server 110 for establishing a connection with the context server 110 and selecting the at least one multimedia program 102 desired to be viewed. Meanwhile, since the predetermined context items are generic settings, redundant items may be contained therein. If the user does not want too many predetermined context items, the user may set up conditions at the filtering means 114 for filtering out his desired context events 112, thereby obtaining personal services. The context server 110 may use a push technique to send the desired and filtered context event 112 of the multimedia program 102 to the client-side device 120.

The aforementioned structured language, audio/video recognition software and push technique are all know to those who are skilled in the art, and thus the details thereof are not described herein.

The client-side device 120 may comprise a middleware means 122, at least one application means 126 and a display device 128. It is noted that, in this embodiment, the middleware means 122 is merely used as an example for explanation, and the functions thereof which will be described later also can be performed by the client-side device 120 itself or built in the at least one application means 126. Therefore, embodiments of the present invention are not limited thereto.

The middleware means 122 is used for receiving and parsing the context event 112 of the multimedia program 102, thereby obtaining at least one set of context event data of the multimedia program 102, as shown in FIG. 1B. The application means 126 is an application. program used for performing at least one action found by program logics based on the at least one set of context event data 124. The user may set up a context-action table at the client-side device 120 for the application means 126 to perform the at least one action, such as displaying the context event data or its related information on the display device 128, responding to the multimedia program 102, etc. The context-action table lists the at least one predetermined context item and the at least one action corresponding thereto, and thus, when the context event data matches with a certain predetermined context item, the action corresponding to the certain predetermined context will be performed. In addition to the application of context-action table, the application means also may use other methods to perform the desirable actions. Further, the application means 126 also can be linked to Internet 130 for performing the action of obtaining information related to the context event data 124, such as the related introduction of the program title AA, the related background of the character BB, the purposes or online shopping sites related to the object CC, the related features of the location DD, etc. The application means 126 also may sort the at least one set of context event data 124 of the multimedia program 102 in accordance with at least one predetermined factor, such as user favorites, data categories, friend's recommendations, etc., thereby allowing the important context event data to be first shown or processed.

It can be known from the above that the application means 126 is linked to the TV or radio programs more flexibly than the conventional “synchronization with time” is, and thereby the application programs interactive with the multimedia programs can be fabricated separately or developed by independent third parties and still maintaining linkage operations between the client-side device 120 and the multimedia programs.

Hereinafter, according to an embodiment of the present invention, a method for synchronizing with a multimedia program is described.

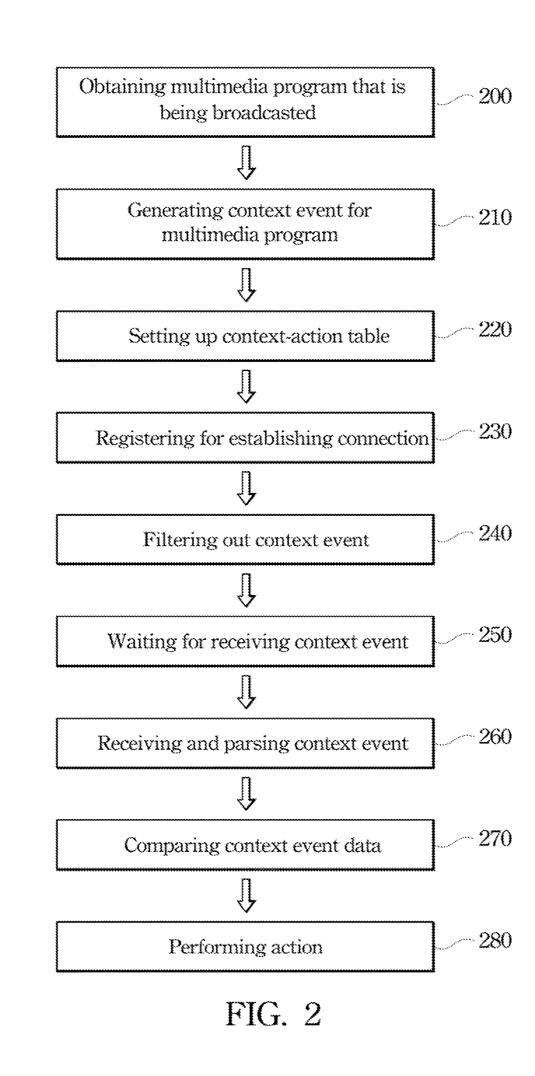

Referring to FIG. 2, FIG. 2 is a flow chart showing a method for synchronizing with a multimedia program according to an embodiment of the present invention. The method for synchronizing with a multimedia program may be implemented as a computer program product stored in a computer-readable storage medium. When a computer reads the computer program product from the computer-readable storage medium and executes the computer program product, the method for synchronizing with a multimedia program is performed. The computer-readable storage medium may be a read only memory (ROM), a flash memory, a floppy disk, a hard disk, an optical disk, a flash drive, a magnetic tap, a network accessible database or any similar computer-readable storage medium obvious to those who are skilled in the art.

In the method for synchronizing with a multimedia program according to this embodiment, at first, in the context server, step 200 is performed for obtaining at least one multimedia program that is being broadcasted. Then, step 210 is performed for generating at least one context event for each multimedia program in accordance with occurrence of at least one predetermined context item in context contents of each multimedia program. Meanwhile, in the client-side device, step 220 is performed for setting up a context-action table, wherein the at least one predetermined context item and the at least one action corresponding thereto are set up in the context-action table. Then, step 230 is performed for registering with the context server for establishing a connection therewith and selecting the at least one multimedia program. Thereafter, step 240 is performed for selecting at least one filtering conditions for filtering out the at least one context event of the multimedia program. Then, step 250 is performed for waiting for receiving the context event. Step 260 is performed for receiving and parsing the context event of each multimedia program, thereby obtaining at least one set of context event data of the multimedia program. Thereafter, step 270 is performed for comparing the set of context event data to the context-action table, thereby determining at least one action corresponding to the predetermined context item matching with the set of context event data. Then, step 280 is performed for performing at least one action based on the result of step 270.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for synchronizing with at least one multimedia program that is being broadcasted, the system comprising:
a context server configured to provide at least one context event for each of the at least one multimedia program, wherein the at least one context event is generated in accordance with occurrence of at least one predetermined context item in context contents of each of the at least one multimedia program; and
a client-side device used for receiving and parsing the at least one context event of each of the at least one multimedia program, thereby obtaining at least one set of context event data of each of the at least one multimedia program, the client-side device comprising:
at least one application means for performing at least one action based on the at least one set of context event data.

2. The system of claim 1, wherein the at least one application means is linked to Internet.

3. The system of claim 1, wherein the client-side device further comprises:
a display device provided for the at least one application means to display the at least one set of context event data.

4. The system of claim 1, wherein the at least one application means performs the at least one action by comparing the at least one set of context event data of each of the at least one multimedia program to a context-action table in which the at least one predetermined context item and the at least one action corresponding to the at least one predetermined context item are set up.

5. The system of claim 1, wherein the at least one application means sorts the at least one set of context event data of each of the at least one multimedia program in accordance with at least one predetermined factor.

6. The system of claim 1, wherein the at least one predetermined context item is selected from the group consisting of a scene switch, a character showing up, an event occurrence, a critical voice appearing and combinations thereof.

7. The system of claim 1, wherein the context server comprises:
a registration means for allowing the client-side device to registering and establishing a connection with the context server, and selecting the at least one multimedia program.

8. The system of claim 1, wherein the context server comprises:
a filtering means for allowing the client-side device to select at least one filtering conditions for filtering out the at least one context event of each of the at least one multimedia program.

9. The system of claim 1, wherein the context server sends the at least one context event of each of the at least one multimedia program to the client-side device by using a push technique.

10. The system of claim 1, wherein the context server is a cloud server.

11. The system of claim 1, wherein the client-side device is a hand-held device.

12. A method for synchronizing with at least one multimedia program that is being broadcasted, the method comprising:
obtaining the at least one multimedia program that is being broadcasted;
generating at least one context event for each of the at least one multimedia program in accordance with occurrence of at least one predetermined context item in context contents of each of the at least one multimedia program;
receiving and parsing the at least one context event of each of the at least one multimedia program, thereby obtaining at least one set of context event data of each of the at least one multimedia program; and
performing at least one action based on the at least one set of context event data.

13. The method of claim 12, wherein the at least one context event is generated by using audio/video recognition software.

14. The method of claim 12, wherein the at least one context event is generated by using an artificial recognition method.

15. The method of claim 12, wherein the at least one action comprises:
linking to Internet for obtaining information related to the at least one set of context event data.

16. The method of claim 12, wherein the at least one action comprises:
displaying the at least one set of context event data.

17. The method of claim 12, wherein the at least one action comprises:
sorting the at least one set of context event data of each of the at least one multimedia program in accordance with at least one predetermined factor.

18. The method of claim 12, wherein the at least one predetermined context item is selected from the group consisting of a scene switch, a character showing up, an event occurrence, a critical voice appearing and combinations thereof.

19. The method of claim 12, further comprising:
setting up a context-action table comprising the at least one predetermined context item and the at least one action corresponding to the at least one predetermined context item;
performing the at least one action by comparing the at least one set of context event data of each of the at least one multimedia program to the context-action table.

20. The method of claim 12, further comprising:
selecting at least one filtering conditions for filtering out the at least one context event of each of the at least one multimedia program.

21. The method of claim 12, wherein the at least one multimedia program is being broadcasted by at least one television station or radio station.

22. The method of claim 12, wherein the at least one context event is shown in a structured language format.

23. A computer program product for synchronizing with at least one multimedia program that is being broadcasted, which, when executed, performs the method of claim 12.
